(19) United States
(12) Patent Application Publication
(10) Pub. No.: US 2024/0110025 A1
(43) Pub. Date: Apr. 4, 2024

(54) ANION EXCHANGE POLYMERS AND MEMBRANES FOR ELECTROLYSIS

(71) Applicant: UOP LLC, Des Plaines, IL (US)

(72) Inventors: Haitao Qian, Buffalo Grove, IL (US); Chunqing Liu, Arlington Heights, IL (US); Xueliang Dong, Schaumburg, IL (US); Nicholas Haxel, Mount Prospect, IL (US)

(21) Appl. No.: 17/823,975

(22) Filed: Sep. 1, 2022

(51) Int. Cl. C08J 5/22; H01M 8/1004

(52) U.S. Cl. CPC C08J 5/2256; H01M 8/1004; C08J 2339/04; H01M 2008/1095

(57) ABSTRACT

Anion exchange polymers comprise a plurality of repeating units of formula (I). The polymer may be synthesized from a super acid catalyzed polyhydroxyalkylation reaction of monomers Ar₁′, Ar₂′, and X₁′ to form a neutral precursor polymer followed by a Menshutkin reaction to convert the neutral precursor polymer to the anion exchange polymer.

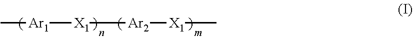

Anion exchange membranes and membrane electrode assemblies incorporating the anion exchange polymers are also described.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

Water electrolysis reaction:2H₂O→2H₂+O₂ (1)

Oxidation reaction at anode for PEMWE:2H₂O→O₂+4H⁺+4e⁻ (2)

Reduction reaction at cathode for PEMWE:2H⁺+2e⁻→H₂ (3)

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂225 and O₂ 230 produced in the water electrolysis reaction. The AEM 215 allows the hydrogen 225 to be produced under high pressure up to about 35 bar with very high purity of at least 99.9%.

Reduction reaction at cathode for AEMWE:4H₂O+4e⁻→2H₂+4OH⁻ (4)

Oxidation reaction at anode for AEMWE:4OH⁻→2H₂O+O₂+4e⁻ (5)

AEMWE has an advantage over PEMWE because it permits the use of less expensive platinum metal-free catalysts, such as Ni and Ni alloy catalysts. In addition, much cheaper stainless steel bipolar plates can be used in the gas diffusion layers (GDL) for AEMWE, instead of the expensive Pt-coated Ti bipolar plates currently used in PEMWE. However, the largest impediments to the development of AEM systems are membrane hydroxyl ion conductivity and stability, as well as lack of understanding of how to integrate catalysts into AEM systems. Research on AEMWE in the literature has been focused on developing electrocatalysts, AEMs, and understanding the operational mechanisms with the general objective of obtaining a high efficiency, low cost and stable AEMWE technology.

Fuel cells, as a next generation clean energy resource, convert the energy of chemical reactions such as an oxidation/reduction redox reaction of hydrogen and oxygen into electric energy. The three main types of fuel cells are alkaline electrolyte fuel cells, polymer electrolyte membrane fuel cells, and solid oxide fuel cells. Polymer electrolyte membrane fuel cells may include proton exchange membrane fuel cells (PEMFC), anion exchange membrane fuel cells (AEMFC), and direct methanol fuel cells. PEMFC uses a PEM to conduct protons from the anode to the cathode, and it also separates the H₂ and O₂ gases to prevent gas crossover. AEMFC uses an AEM to conduct OH⁻ from the cathode to the anode, and it also separates the H₂ and O₂ gases to prevent gas crossover.

The anode in an electrochemical cell is the electrode at which the predominant reaction is oxidation (e.g., the water oxidation/oxygen evolution reaction electrode for a water electrolyzer, or the hydrogen oxidation electrode for a fuel cell). The cathode in an electrochemical cell is the electrode at which the predominant reaction is reduction (e.g., the proton reduction/hydrogen evolution reaction electrode for a water electrolyzer, or the oxygen reduction electrode for a fuel cell). The membrane is one of the key materials that make up an electrolysis cell or a fuel cell and is an important driver for safety and performance. Some important properties for membranes for fuel cells and membrane electrolysis include high conductivity, high ionic permeability, high ionic exchange capacity (for ion-exchange membrane), high ionic/H₂ and O₂ selectivity (low H₂ and O₂ permeability/crossover), low price, low area resistance to minimize efficiency loss resulting from ohmic polarization, high resistance to oxidizing and reducing conditions, being chemically inert at a wide pH range, high thermal stability together with high proton conductivity, and high mechanical strength (thickness, low swelling).

Significant advances are needed in cost-effective, high performance, stable catalysts, membrane materials, as well as other cell stack components for AEM water electrolysis and AEMFCs with a wide range of applications in renewable energy systems.

### BRIEF DESCRIPTION OF THE DRAWINGS

FIG. 1 is an illustration of one embodiment of a PEMWE cell.

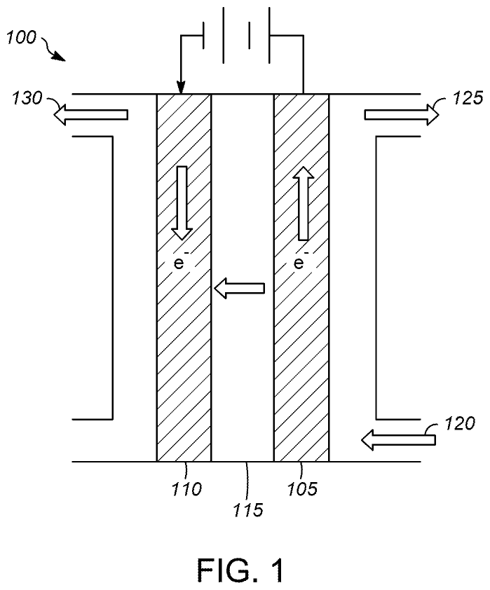

FIG. 2 is an illustration of one embodiment of a AEMWE cell.

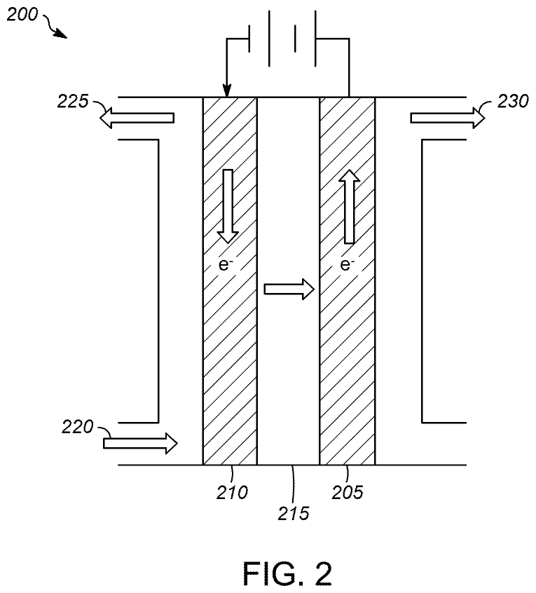

FIG. 3 is an illustration of one embodiment of the synthesis of a poly(terphenylene-co-phenanthrenylene piperidinium iodide) (abbreviated as PTPP-I) anion exchange polymer.

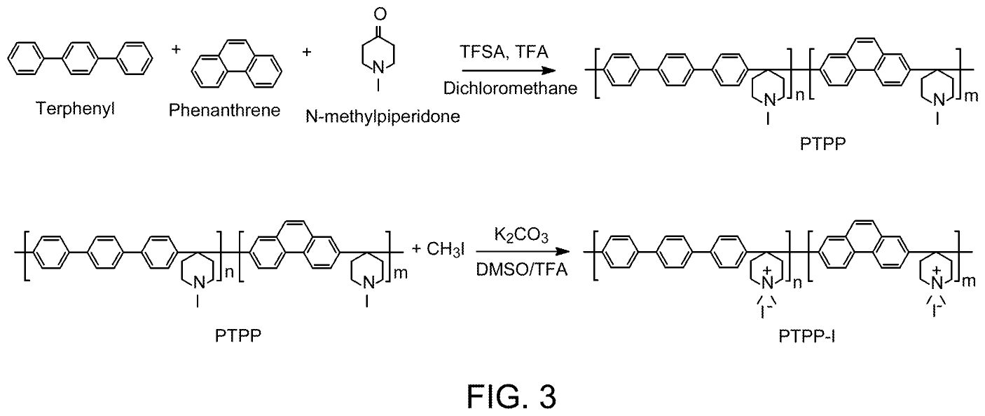

### DESCRIPTION OF THE INVENTION

Novel anion exchange polymers comprising a plurality of repeating units of formula (I)

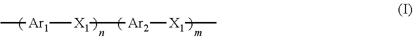

have been developed for the preparation of AEMs. The anion exchange polymers have stable hydrophobic polymer backbones comprising linear aromatic units, such as biphenyl and terphenyl, and polycyclic aromatic units, such as naphthalene and phenanthrene. Cationic groups, like piperidinium, quaternized carbazole derivative, quaternized phenothiazine derivative, or piperidinium salt, were covalently incorporated into the polymers for the preparation of novel AEMs. Therefore, these polymers provide high OH⁻ conductivity, high chemical stability, low swelling in alkaline water at about 60-120° C., and high mechanical stability. The anion exchange polymers can be used for electrolysis, such as water or CO₂ electrolysis, as well as other uses such as redox flow batteries, and fuel cell applications.

The anion exchange polymers were designed to achieve: high OH⁻ conductivity by incorporating a piperidinium, or a piperidinium salt, or both into the polymer side chain; high chemical stability by having an polymer backbone free of ether bonds; and high mechanical strength due to high polymer backbone rigidity and molecular weight by incorporating both linear aromatic units, such as biphenyl and terphenyl, and polycyclic aromatic units, such as naphthalene and phenanthrene, into the polymer main backbone. The polymers have hydrophilic anion exchange functional groups such as piperidinium functional groups on the polymer side chains and stable hydrophobic polymer main backbones free of ether bonds comprising linear aromatic units, such as biphenyl and terphenyl, and polycyclic aromatic units, such as naphthalene and phenanthrene, which enable efficient and stable operation in water or CO₂ electrolysis, redox flow battery, and fuel cell applications.

One aspect of the invention is an anion exchange polymer. In one embodiment, the polymer comprises a plurality of repeating units of formula (I)

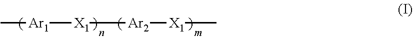

wherein Ar₁ is selected from the group consisting of:

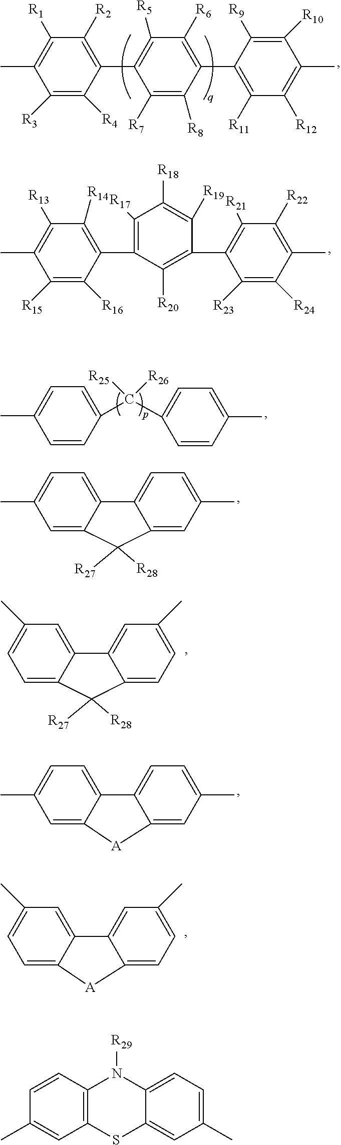

and mixtures thereof;

Ar₂ is selected from the group consisting of:

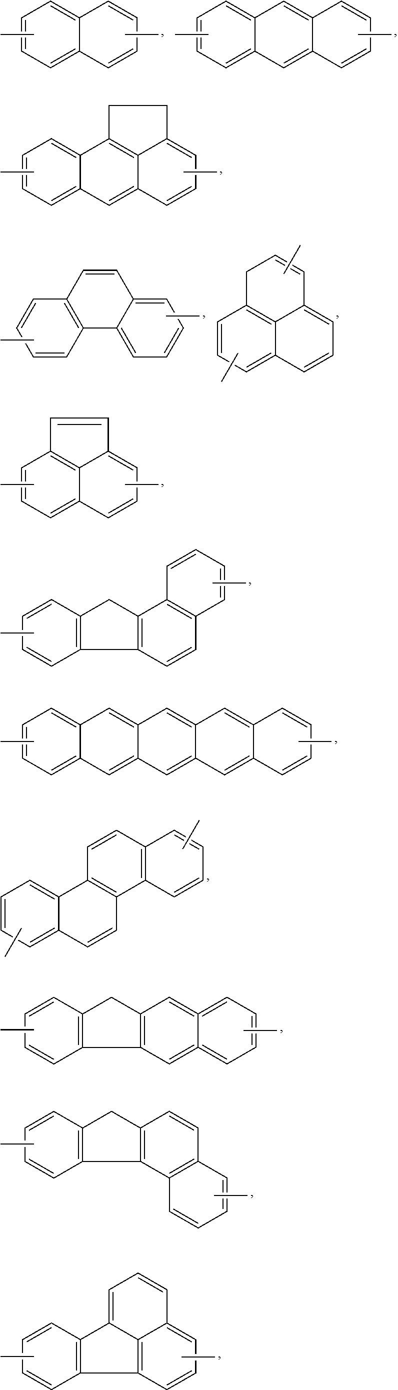

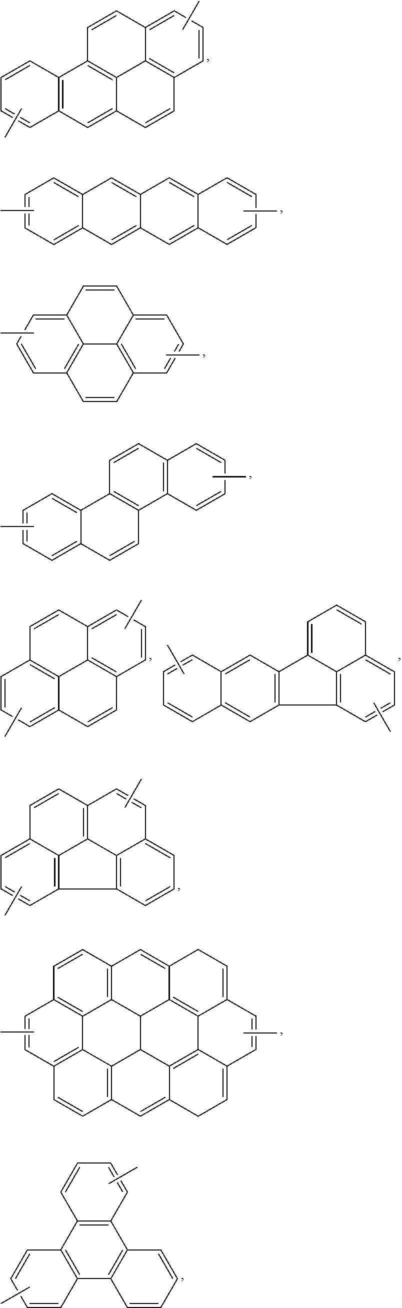

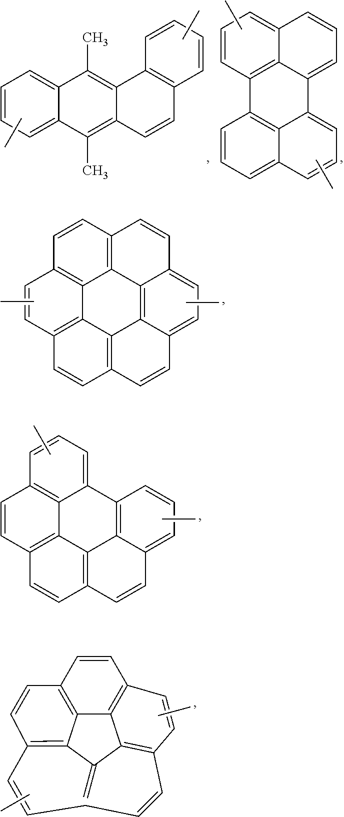

and mixtures thereof;

X₁ is selected from the group consisting of:

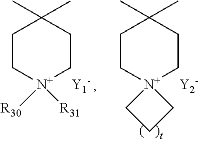

optionally

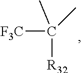

and mixtures thereof;
wherein Y₁⁻ and Y₂⁻ are anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein m is an integer from 5 to 500;
wherein n is an integer from 0 to 500 and the molar ratio of n/m is in a range of 0:1 to 20:1;
wherein p is 1, 2, 3, or 4;
wherein q is 0, 1, 2, or 3; and
wherein t is 1, 2, 3, 4, 5, or 6.

In some embodiments, Ar₁ is selected from the group consisting of

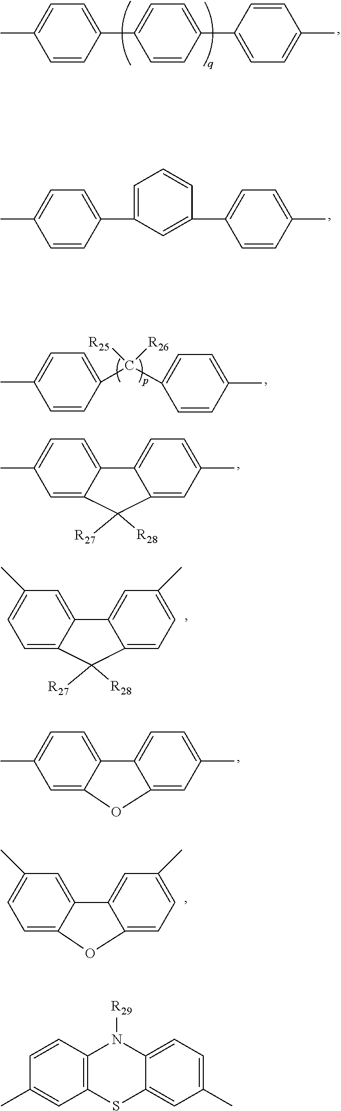

and mixtures thereof;
wherein R₂₅, R₂₆, R₂₇, and R₂₈ are each independently —H or —CH₃;
wherein p is 1 or 2; and
wherein q is 0 or 1.

In some embodiments, Ar₂ is selected from the group consisting of

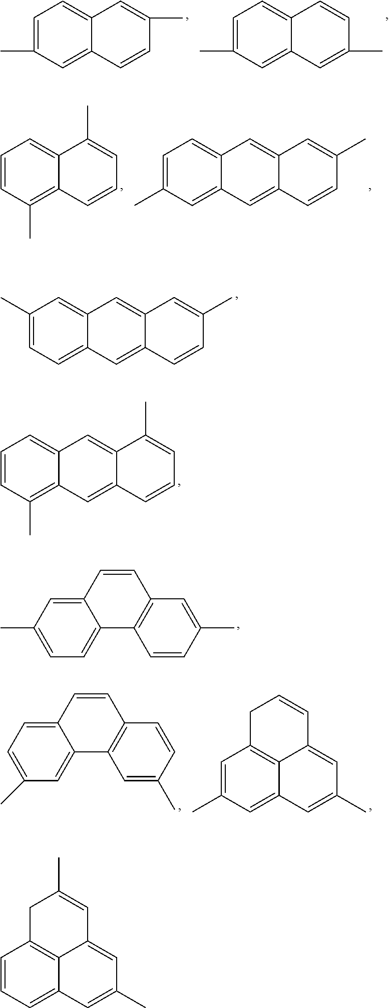

and mixtures thereof.

In some embodiments, Ar₂ is selected from the group consisting of

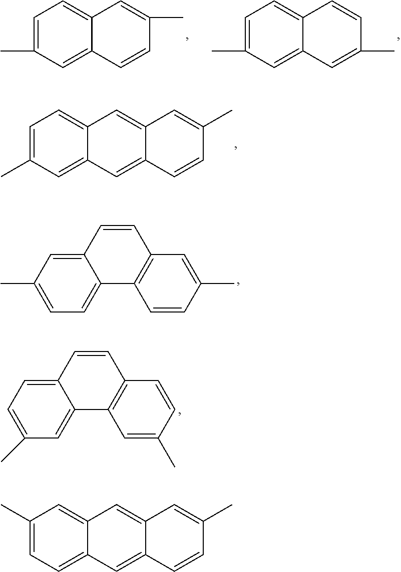

and mixtures thereof.

In some embodiments, X₁ is

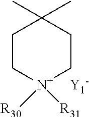

and wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂; and
wherein Y₁⁻ is HCO₃⁻, OH⁻ or I⁻.

In some embodiments, X₁ is

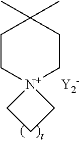

wherein t is 1, 2, 3, 4, 5, or 6; and
wherein Y₂ is HCO₃⁻, OH⁻ or I⁻.

In some embodiments, X₁ is a mixture of

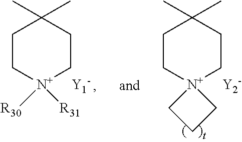

wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂;
wherein t is 1, 2, 3, 4, 5, or 6; and
wherein Y₁⁻ and Y₂⁻ are selected from HCO₃⁻, OH⁻ or I⁻.

In some embodiments, the polymer comprising a plurality of repeating units of formula (I) is formed from a superacid catalyzed polyhydroxyalkylation reaction of monomers Ar₁′, Ar₂′, and X₁′ followed by a Menshutkin reaction, wherein Ar₁′ is selected from the group consisting of:

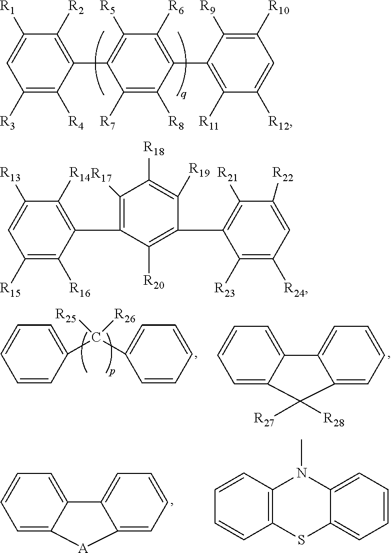

and mixtures thereof,
Ar₂′ is selected from the group consisting of:

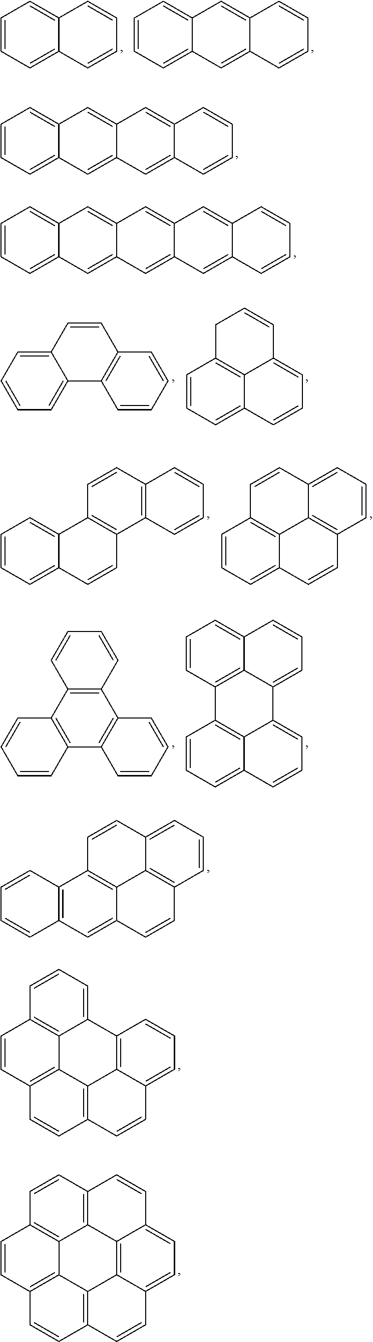

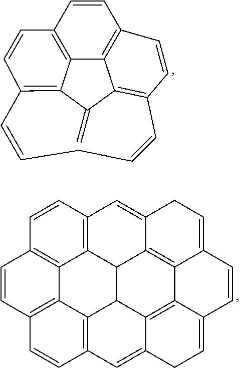

and mixtures thereof; and
X₁′ is selected from the group consisting of.

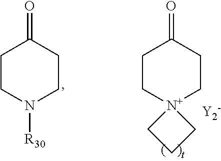

optionally

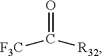

and mixtures thereof;
wherein Y₂⁻ is an anion;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉ and R₃ are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein p is 1, 2, 3, or 4;
wherein q is 0, 1, 2, or 3; and wherein t is 1, 2, 3, 4, 5, or 6.

In some embodiments, Ar₁′ is selected from the group consisting of:

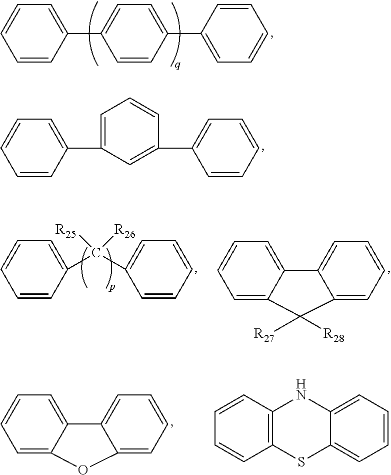

and mixtures thereof;
wherein R₂₅, R₂₆, R₂₇, and R₂₈ are each independently —H or —CH₃;
wherein p is 1 or 2; and
wherein q is 0 or 1.

In some embodiments, Ar₂′ is selected from the group consisting of:

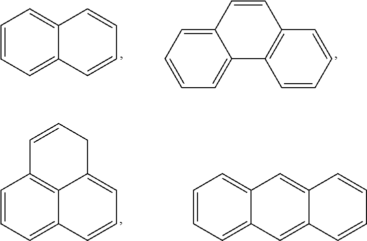

and mixtures thereof.

In some embodiments, wherein Ar₂′ is selected from the group consisting of:

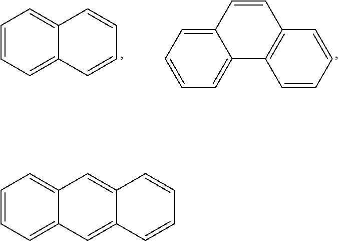

and mixtures thereof.

In some embodiments, X₁′ is

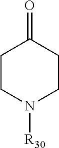

and wherein R₃₀ is —H, —CH₃, —CH₂CH₃, —CH(CH₃)₂, —C(CH₃)₃, —CH₂—C₆H₅, or —CH₂—CH(CH₃)₂.

In some embodiments, X₁′ is

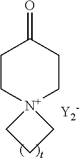

and wherein t is 1, 2, 3, 4, 5, or 6.

In some embodiments, X₁′ is a mixture of

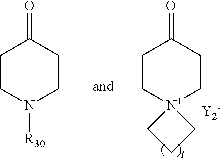

wherein R₃₀ is —H, —CH₃, —CH₂CH₃, —CH(CH₃)₂, —C(CH₃)₃, —CH₂—C₆H₅, or —CH₂—CH(CH₃)₂;
and wherein t is 1, 2, 3, 4, 5, or 6.

The anion exchange polymer comprising a plurality of repeating units of formula (I) may be synthesized by two steps: 1) a superacid catalyzed polyhydroxyalkylation reaction of monomers Ar₁′ and Ar₂′ with X₁′, such as p-terphenyl as Ar₁′ and phenanthrene as Ar₂′ with N-methyl-4-piperidone as X₁′, to form a neutral precursor polymer; and 2) a Menshutkin reaction to convert the neutral precursor polymer with functional groups, such as piperidine-based groups, to the anion exchange polymer comprising a plurality of repeating units of formula (I) with anion-conducting functional groups, such as piperidinium-based cation groups. Optionally, the anion exchange polymer comprising a plurality of repeating units of formula (I) with anion-conducting functional groups, such as piperidinium-based cation groups and negatively charged halide ions or bicarbonate ions is converted to an anion exchange polymer comprising a plurality of repeating units of formula (I) with anion-conducting functional groups, such as piperidinium-based cation groups and negatively charged OH⁻ ions by soaking in a base solution after the polymer is made into a membrane.

The polyhydroxyalkylation reaction of monomers Ar₁′ and Ar₂′ with monomer X₁′ provides an anion exchange polymer with a polymer backbone free of ether bonds, which results in high chemical stability of the polymer. The incorporation of electron-rich monomer Ar₁′ and Ar₂′ into the anion exchange polymer provides a hydrophobic polymer backbone free of ether bonds and the incorporation of monomer X₁′ into the anion exchange polymer provides piperidinium derivative or piperidinium salt derivative anion-conducting functional groups, or both, that help achieve stable high OH⁻ conductivity. The incorporation of monomer Ar₁′ and Ar₂′ into the anion exchange polymer provides the polymer with high mechanical strength due to high polymer backbone rigidity and molecular weight. The combination of the hydrophobic polymer backbone with high mechanical strength, the hydrophilic polymer side chains, and alkaline stable hydrophilic piperidinium cationic groups provides the novel anion exchange polymer with high OH⁻ conductivity, high chemical stability, high mechanical strength, and long-term performance stability.

The molar ratio of Ar₁′ monomer to Ar₂′ monomer can be in a range of 0:1 to 20:1, or in a range of 0:1 to 10:1, or in a range of 0:1 to 5:1. The molar ratio of X₁′monomer to Ar₁′ and Ar₂′ monomers can be in a range of 1.2:1 to 1:1.2, or in a range of 1.1:1 to 1:1.1, or in a range of 1.05:1 to 1:1.05.

The superacid catalyzed polyhydroxyalkylation reaction can be carried out at −10° C. to 50° C., or at −5° C. to 30° C., or at −5° C. to 25° C. for 2 h to 72 h, or 10 h to 48 h, or 12 to 24 h. Suitable superacid catalysts include, but are not limited to, trifluoromethanesulfonic acid (CF₃SO₃H (TFSA)), methanesulfonic acid (MSA), fluorosulfuric acid (FSO₃H), or mixtures thereof. Solvents for the polyhydroxyalkylation reaction are those that can dissolve one or more of the monomers. Suitable solvents include, but are not limited to, methylene chloride, chloroform, trifluoroacetic acid (TFA), or mixtures thereof.

The Menshutkin reaction is used to react the neutral precursor polymer with an alkyl halide, or with an alkyl amine first followed by an alkyl halide to convert the neutral precursor polymer to the anion exchange polymer comprising a plurality of repeating units of formula (I) with linear aromatic units, such as biphenyl and terphenyl, polycyclic aromatic units, such as naphthalene and phenanthrene, and stable cationic ion-conducting functional groups, such as piperidinium, quaternized carbazole derivative, quaternized phenothiazine derivative, and piperidinium salt. Suitable alkyl halides include, but are not limited to, alkyl iodides or alkyl bromides. Suitable alkyl amines include, but are not limited to, trimethyl amine or triethyl amine. The Menshutkin reaction can be carried out at 10° C. to 80° C., or at 20° C. to 30° C. for 2 h to 72 h, or 10 h to 48 h, or 12 to 24 h. Solvents for the Menshutkin reaction are those that can dissolve the neutral precursor polymer. Suitable solvents include, but are not limited to, N-methylpyrrolidone (NMP), N,N-dimethyl acetamide (DMAC), N,N-dimethylformamide (DMF), dimethyl sulfoxide (DMSO), 1,3-dioxolane, or mixtures thereof.

The anion exchange polymer comprising a plurality of repeating units of formula (I) has a weight average molecular weight in a range of 10,000 to 1,000,000 Daltons, or in a range of 50,000 to 500,000 Daltons.

Another aspect of the invention is an anion exchange membrane comprising the polymer described above. The anion exchange membrane may be used in a wide variety of applications including, but not limited to, fuel cells, electrolyzers, flow batteries, electrodialyzers, waste metal recovery systems, electrocatalytic hydrogen production systems, desalinators, water purifiers, waste water treatment systems, ion exchangers, or CO₂ separators.

In some embodiments, the anion exchange membrane comprises a nonporous symmetric dense film membrane, an integrally-skinned asymmetric membrane, a reinforced composite membrane, or a thin film composite membrane. By “dense” we mean that the membrane does not have pores larger than 1 nm.

In some embodiments, the reinforced composite membrane or the thin film composite membrane comprises a porous substrate membrane impregnated or coated with the anion exchange polymer. The porous substrate membrane is prepared from a polymer different from the anion exchange polymer.

In some embodiments, the nonporous symmetric dense film membrane, the integrally-skinned asymmetric membrane, the reinforced composite membrane, or the thin film composite membrane may be a flat sheet membrane.

In some embodiments, the nonporous symmetric dense film anion exchange membrane is prepared using a method comprising: 1) dissolving the anion exchange polymer in a solvent to form a polymer casting solution; 2) casting the polymer casting solution on a nonporous substrate to form a uniform layer of the polymer casting solution; 3) drying the polymer casting solution layer to form a dried membrane on the nonporous substrate at 50° C. to 180° C., or at 50° C. to 120° C., or at 80° C. to 120° C.; and optionally 4) ion exchanging the halide anions of the anion exchange polymer in the membrane with hydroxide, bicarbonate, carbonate ions, or a combination thereof to form the nonporous symmetric dense film anion exchange polymer membrane. The nonporous substrate is removed from the membrane when the membrane is used in a desired application. The solvent used to dissolve the anion exchange polymer can be selected from, but is not limited to, NMP, DMAC, DMF, DMSO, 1,3-dioxolane, or mixtures thereof. The nonporous substrate used for the fabrication of the nonporous symmetric dense film membrane can be selected from, but is not limited to, glass plate, polyolefin film, polyimide film, polyester film, or fluorocarbon-based polymer film such as poly(tetrafluoroethylene) (PTFE) and poly(vinylidene fluoride) (PVDF) film.

In some embodiments, the integrally-skinned asymmetric anion exchange membrane is prepared using a method comprising: 1) making an anion exchange polymer membrane casting solution comprising the anion exchange polymer with formula (I), solvents which are miscible with water and can dissolve the anion exchange polymer, and non-solvents which cannot dissolve the anion exchange polymer; 2) casting a layer of the anion exchange polymer membrane casting solution onto a supporting substrate; 3) evaporating the solvent and non-solvent from the surface of the coated layer and then coagulating the coated polymer layer in a coagulating bath to form the integrally-skinned asymmetric membrane structure; 5) drying the membrane at 50° C. to 150° C., or at 50° C. to 120° C., or at 80° C. to 120° C.; and optionally 6) ion exchanging the halide anions of the anion exchange polymer in the membrane with hydroxide, bicarbonate, carbonate ions, or a combination thereof to form the integrally-skinned asymmetric anion exchange polymer membrane. In some embodiments, the supporting substrate is removed from the membrane when the membrane is used in a desired application. In some embodiments, the supporting substrate is part of the final integrally-skinned asymmetric anion exchange polymer membrane. The supporting substrate may comprise polyolefin such as polypropylene and polyethylene, polyester, polyamide such as Nylon 6 and Nylon 6,6, cellulose, or fluorocarbon-based polymer such as PTFE and PVDF. The solvents for the preparation of the integrally-skinned asymmetric membrane include, but are not limited to, NMP, DMAC, DMF, DMSO, dioxanes, 1,3-dioxolane, and mixtures thereof. The non-solvents for the preparation of the integrally-skinned asymmetric membrane include, but are not limited to, acetone, methanol, ethanol, tetrahydrofuran (THF), toluene, n-octane, n-decane, lactic acid, citric acid, isopropanol, and mixtures thereof. The integrally-skinned asymmetric membrane may have a thin nonporous dense layer less than 500 nm on a microporous support layer.

In some embodiments, the reinforced composite anion exchange membrane is prepared using a method comprising: 1) dissolving the anion exchange polymer in a solvent to form a polymer solution; 2) impregnating a porous matrix support membrane with the anion exchange polymer solution to fill the pores with the anion exchange polymer via dip-coating, soaking, spraying, painting, or other known conventional solution impregnating method; 3) drying the impregnated membrane at 50° C. to 150° C., or at 50° C. to 120° C., or at 80° C. to 120° C.; and optionally 4) ion exchanging the halide anions of the anion exchange polymer in the pores of the reinforced membrane with hydroxide, bicarbonate, carbonate ions, or a combination thereof to form the reinforced composite anion exchange membrane with interconnected anion exchange polymer domains in a porous matrix. The solvents for the preparation of the thin film composite anion exchange membrane include, but are not limited to, NMP, DMAC, DMF, DMSO, dioxanes, 1,3-dioxolane, and mixtures thereof. The porous matrix should have good thermal stability (stable up to at least 120° C.), high stability under high pH condition (e.g., pH greater than 8), high resistance to oxidizing and reducing conditions (insoluble and no performance drop under oxidizing and reducing conditions), high mechanical strength (no dimensional change under the system operation conditions), as well as other factors dictated by the operating conditions for electrochemical reactions. The porous matrix must be compatible with the electrochemical cell chemistry and meet the mechanical demands of cell stacking or winding assembly operations.

The polymers suitable for the preparation of the porous matrix can be selected from, but not limited to, polyolefins such as polyethylene and polypropylene, polyamide such as Nylon 6 and Nylon 6,6, polyester, cellulose acetate, polybenzimidazole, fluorocarbon-based polymer such as PTFE and PVDF, polycarbonate, cellulose, or combinations thereof. These polymers provide a range of properties such as low cost, high stability in alkaline water, good mechanical stability, and ease of processability for porous matrix fabrication.

The porous matrix can either a non-woven matrix or a woven matrix and have either a symmetric porous structure or an asymmetric porous structure. The porous matrix can be formed by an electrospinning process, a phase inversion membrane fabrication approach followed by direct air drying, or by phase inversion followed by solvent exchange methods. The porous matrix also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the pores. The wet processing of polyolefin porous matrix is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the porous matrix can be in a range of 10-400 micrometers, or a range of 10-200 micrometers, or a range of 10-100 micrometers, or a range of 20-100 micrometers. The pore size of the porous matrix can be in a range of 1 micrometer to 500 micrometers, or a range of 10 micrometer to 200 micrometers, or a range of 50 micrometers to 100 micrometer.

In some embodiments, the thin film composite anion exchange membrane is prepared using a method comprising: 1) dissolving the anion exchange polymer in a solvent to form a polymer coating solution; 2) coating a layer of the anion exchange polymer coating solution on one surface of a microporous support membrane via dip-coating, meniscus coating, spin coating, casting, soaking, spraying, painting, or other known conventional solution coating technologies; 3) drying the coated membrane at 50° C. to 150° C., or at 50° C. to 120° C., or at 80° C. to 120° C.; and optionally 4) ion exchanging the halide anions of the anion exchange polymer in the coating layer with hydroxide, bicarbonate, carbonate ions, or a combination thereof to form the thin film composite anion exchange membrane. The solvents for the preparation of the thin film composite anion exchange membrane include, but are not limited to, NMP, DMAC, DMF, DMSO, dioxanes, 1,3-dioxolane, and mixtures thereof. The microporous support membrane should have good thermal stability (stable up to at least 120° C.), high stability under high pH condition (e.g., pH greater than 8), high resistance to oxidizing and reducing conditions (insoluble and no performance drop under oxidizing and reducing conditions), high mechanical strength (no dimensional change under the system operation conditions), as well as other factors dictated by the operating conditions for electrochemical reactions. The microporous support membrane must be compatible with the electrochemical cell chemistry and meet the mechanical demands of cell stacking or winding assembly operations.

The polymers suitable for the preparation of the microporous support membrane can be selected from, but not limited to, polyolefins such as polyethylene and polypropylene, polyamide such as Nylon 6 and Nylon 6,6, polyester, cellulose acetate, polybenzimidazole, fluorocarbon-based polymer such as PTFE and PVDF, polycarbonate, cellulose, or combinations thereof. These polymers provide a range of properties such as low cost, high stability in alkaline water, good mechanical stability, and ease of processability for membrane fabrication.

The microporous support membrane can have either a symmetric porous structure or an asymmetric porous structure. The asymmetric microporous support membrane can be formed by a phase inversion membrane fabrication approach followed by direct air drying, or by phase inversion followed by solvent exchange methods. The microporous support membrane also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-400 micrometers, or a range of 10-200 micrometers, or a range of 10-100 micrometers, or a range of 20-100 micrometers. The pore size of the microporous membrane can be in a range of 10 nanometers to 50 micrometers, or a range of 50 nanometers to 10 micrometers, or a range of 0.2 micrometers to 1 micrometer.

Another aspect of the invention is a membrane electrode assembly. In one embodiment, the membrane electrode assembly comprises: an anion exchange membrane comprising the polymer described above; an anode comprising an anode catalyst on a first surface of the anion exchange membrane; and a cathode comprising a cathode catalyst on a second surface of the anion exchange membrane; and

In some embodiments, the membrane electrode assembly further comprises: an anode porous transport layer adjacent to the anode; and a cathode porous transport layer adjacent to the cathode. In some embodiments, the anode and the cathode catalysts are platinum group metal (PGM)-free electrocatalysts. The anode and the cathode catalysts are for oxygen evolution reaction and hydrogen evolution reaction, respectively. The anode and the cathode catalysts should have low cost, good electrical conductivity, and good electrocatalytic activity and stability. Suitable cathode catalysts can be selected from, but are not limited to, Ni-based alloys such as Ni—Mo, Ni—Al, Ni—Cr, Ni—Sn, Ni—Co, Ni—W, and Ni—Al—Mo, metal carbides such as Mo₂C, metal phosphides such as CoP, metal dichalcogenides such as MoSe₂, and mixtures thereof. Suitable anode catalysts can be selected from, but are not limited to, Ni—Fe alloy, Ni—Mo alloy, spinel CuₓCo₃ₓO₃, Ni—Fe layered double hydroxide nanoplates on carbon nanotubes, immobilized metal catalyst on conductive supports, and mixtures thereof.

In some embodiments, the anode comprising an anode catalyst on a first surface of the anion exchange membrane is formed by coating an anode catalyst ink on the first surface of the anion exchange membrane via meniscus coating, knife coating, spray coating, painting, or other known conventional ink coating technologies, followed by drying the coated anion exchange membrane.

In some embodiments, the cathode comprising a cathode catalyst on a second surface of the anion exchange membrane is formed by coating a cathode catalyst ink on the second surface of the anion exchange membrane via meniscus coating, knife coating, spray coating, painting, or other known conventional ink coating technologies, followed by drying the coated anion exchange membrane.

In some embodiments, the anode catalyst ink comprises the anode catalyst, an OH⁻ exchange ionomer as a binder, and a solvent. In some embodiments, the cathode catalyst ink comprises the cathode catalyst, an OH⁻ exchange ionomer as a binder, and a solvent. The OH⁻ exchange ionomer binder creates OH⁻ transport pathways between the membrane and the reaction sites within the electrodes and thus drastically improves the utilization of the electrocatalyst particles while reducing the internal resistance. The OH⁻ exchange ionomer binder can have a chemical structure similar to the anion exchange polymer described above, so that the binder will allow low interfacial resistance and similar expansion in contact with water to avoid catalyst delamination, but OH⁻ conductivity and high oxygen and hydrogen permeance. The solvent can be selected from, but is not limited to, water, alcohol, or a mixture thereof.

The anode porous transport layer and the cathode porous transport layer simultaneously transport electrons, heat, and products with minimum voltage, current, thermal, interfacial, and fluidic losses. The cathode porous transport layer can be made from, but is not limited to, stainless steel, titanium meshes, titanium felts, titanium foams, or carbon-based materials such as non-woven carbon paper, non-woven carbon cloth, or woven carbon cloth. The anode porous transport layer can be made from, but is not limited to, stainless steel, titanium meshes, titanium felts, or titanium foams.

### EXAMPLES

### Example 1: Synthesis of poly(terphenylene-co-phenanthrenylene piperidine) polymer (abbreviated as PTPP)

Terphenyl (10.36 g, 45 mmol), phenanthrene (0.89 g, 5 mmol) and 1-methyl-4-piperidone (6.22 g, 55 mmol) were mixed with 40 mL of dichloromethane and cooled in icy water to 0° C. To the stirred mixture trifluoroacetic acid (6 mL) and trifluoromethanesulfonic acid (40 mL) were added dropwise consecutively under stirring. The mixture was stirred for 11 hours while kept at 0° C. The reaction mixture was blended with 1 L of water to generate a slurry. The slurry was filtered and rinsed with 1 L of water, after which the filter cake was soaked in 1 L of water containing 5 g of sodium hydroxide overnight. The mixture was again filtered, and the filter cake was washed with water until pH neutral. The obtained solid was then dried at 60° C. overnight, followed by drying under vacuum at 80° C. overnight.

### Example 2: Synthesis of poly(terphenylene-co-phenanthrenylene piperidinium iodide) (abbreviated as PTPP-I)

The obtained PTPP polymer (about 50 mmol of piperidine units) was dissolved in 160 mL of dimethyl sulfoxide containing 4 mL of trifluoroacetic acid. To the solution iodomethane (150 mmol) and anhydrous potassium carbonate (180 mmol) were added. While protected from light, the mixture was stirred for 24 hours. The reaction mixture was poured in 1 L of ethyl acetate. The obtained mixture was filtered, and the filter cake was washed with 500 mL of ethyl acetate and water until pH neutral. The obtained solid was dried at 60° C. overnight.

### Example 3: Preparation of poly(terphenylene-co-phenanthrenylene

piperidinium hydroxide) (abbreviated as PTPP-OH) anion exchange polymer membrane

A PTPP-1 anion exchange polymer membrane was prepared by dissolving the PTPP-I anion exchange polymer (5.0 g) in DMSO (20 g), casting the solution on a clean substrate, and drying at 60° C. overnight. The membrane was peeled off the substrate and further dried in a vacuum oven at 100° C. for 48 h. The membrane was ion exchanged in 1 M KOH aqueous solution for 10 h to convert PTPP-1 anion exchange polymer with I⁻ anions to an anion exchange polymer with OH⁻ anions to form poly(terphenylene-co-phenanthrenylene piperidinium hydroxide) anion exchange polymer membrane (abbreviated as PAPP-OH membrane). The in-plane hydroxide conductivity of the PAPP-OH membrane was 124.7 mS/cm at room temperature.

### Specific Embodiments

While the following is described in conjunction with specific embodiments, it will be understood that this description is intended to illustrate and not limit the scope of the preceding description and the appended claims.

A first embodiment of the invention is an anion exchange polymer comprising a plurality of repeating units of formula (I)

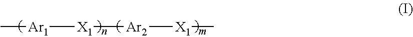

wherein Ar₁ is selected from the group consisting of

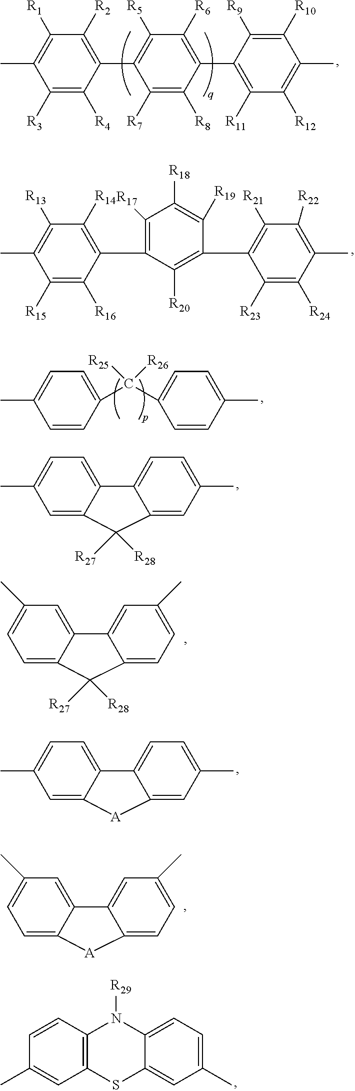

and mixtures thereof, Ar₂ is selected from the group consisting of

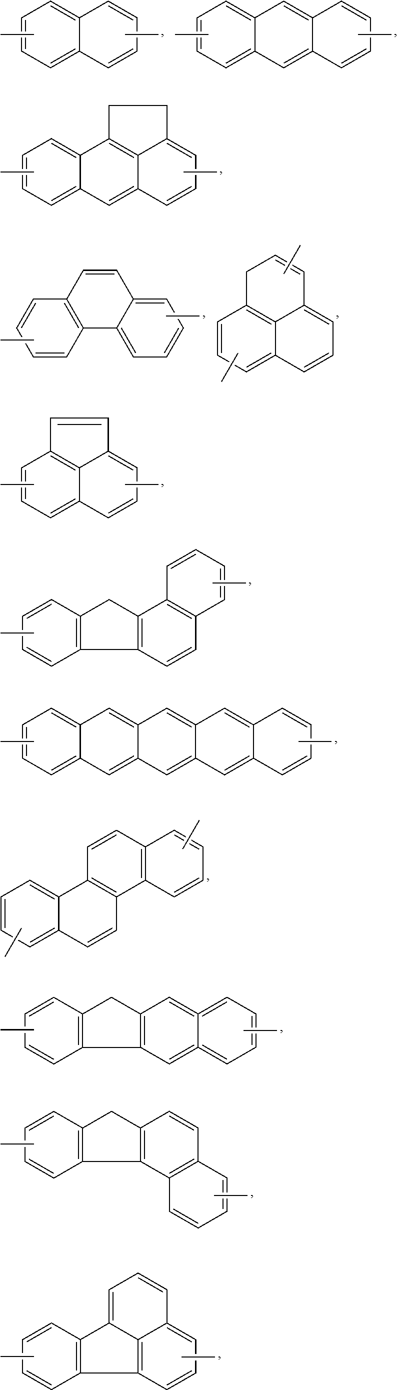

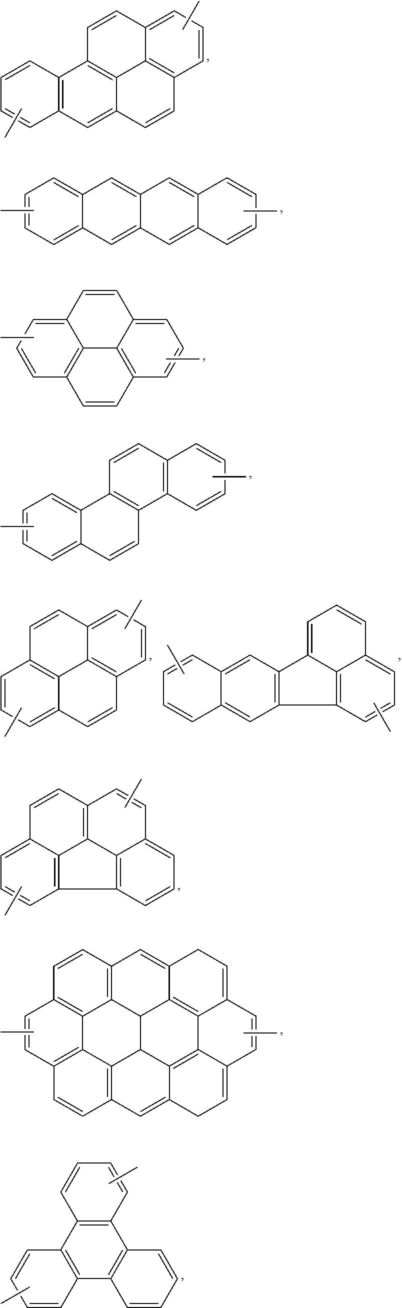

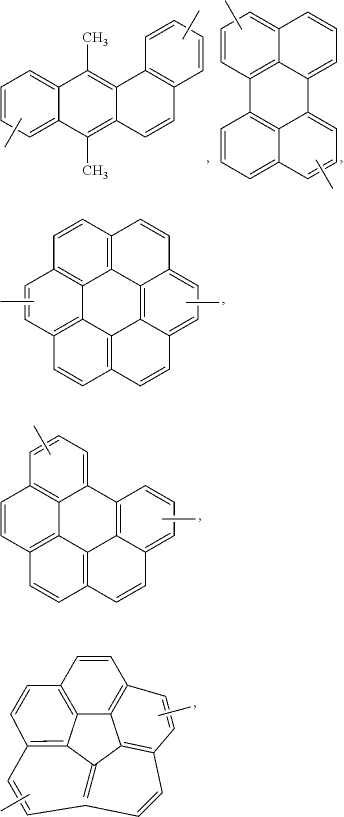

and mixtures thereof; X₁ and selected from the group consisting of

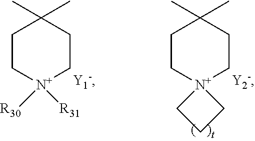

optionally

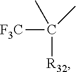

and mixtures thereof, wherein Y₁⁻ and Y₂⁻ are anions; wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group; wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group; wherein R₃₂ is an alkyl group, an alkenyl group, an alkynyl group, or an aryl group, and the alkyl, alkenyl, alkynyl or aryl group is optionally substituted with a halide or a positively charged functional group; wherein A is O, S, or NR₁₀₀; wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group; wherein m is an integer from 5 to 500; wherein n is an integer from 0 to 500 and the molar ratio of n/m is in a range of 0:1 to 20:1; wherein p is 1, 2, 3, or 4; wherein q is 0, 1, 2, or 3; and wherein t is 1, 2, 3, 4, 5, or 6. An embodiment of the invention is one, any or all of prior embodiments in this paragraph up through the first embodiment in this paragraph wherein Ar₁ is selected from the group consisting of

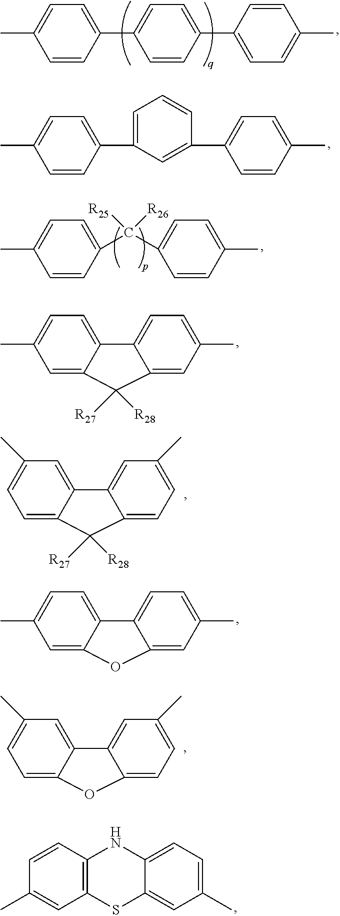

and mixtures thereof, wherein R₂₅, R₂₆, R₂₇, and R₂₈ are each independently —H or —CH₃, wherein p is 1 or 2; and wherein q is 0 or 1. An embodiment of the invention is one, any or all of prior embodiments in this paragraph up through the first embodiment in this paragraph wherein Ar₂ is selected from the group consisting of

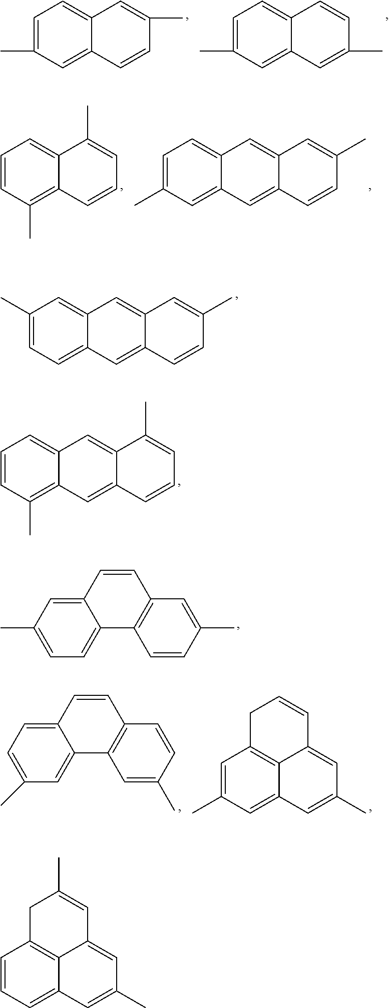

and mixtures thereof. An embodiment of the invention is one, any or all of prior embodiments in this paragraph up through the first embodiment in this paragraph wherein Ar₂ is selected from the group consisting of

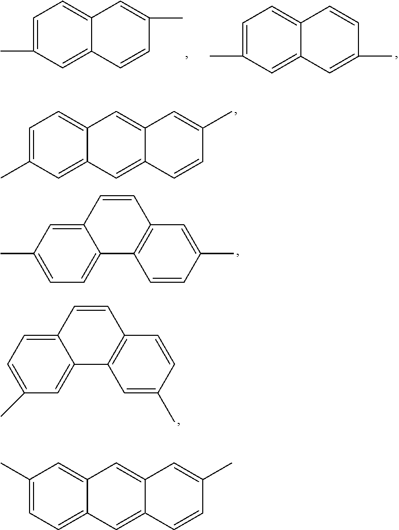

and mixtures thereof. An embodiment of the invention is one, any or all of prior embodiments in this paragraph up through the first embodiment in this paragraph wherein X₁ is

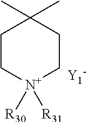

and wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂; and wherein Y₁⁻ is HCO₃⁻, OH or I⁻. An embodiment of the invention is one, any or all of prior embodiments in this paragraph up through the first embodiment in this paragraph wherein X₁ is

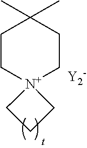

wherein t is 1, 2, 3, 4, 5, or 6; and wherein Y₂ is HCO₃⁻, OH⁻ or I⁻. An embodiment of the invention is one, any or all of prior embodiments in this paragraph up through the first embodiment in this paragraph wherein X₁ is a mixture of

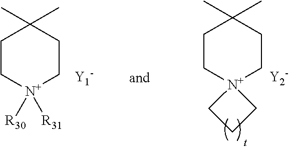

wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂; wherein t is 1, 2, 3, 4, 5, or 6; and wherein Y₁⁻ and Y₂⁻ are selected from HCO₃⁻, OH⁻ or P. An embodiment of the invention is one, any or all of prior embodiments in this paragraph up through the first embodiment in this paragraph wherein the anion exchange polymer is synthesized from monomers Ar₁′, Ar₂′, and X₁′ wherein Ar₁′ is selected from the group consisting

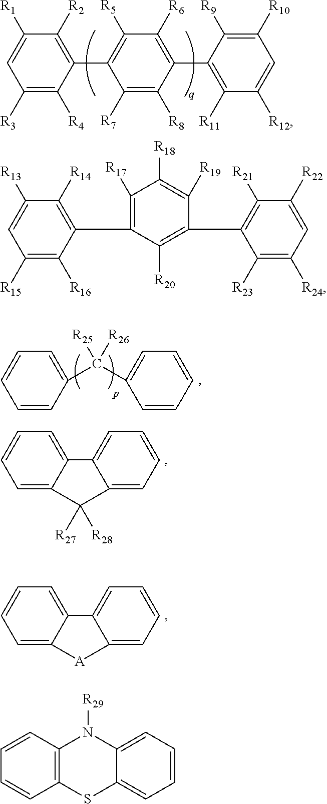

and mixtures thereof.

Ar₂′ is selected from the group consisting of

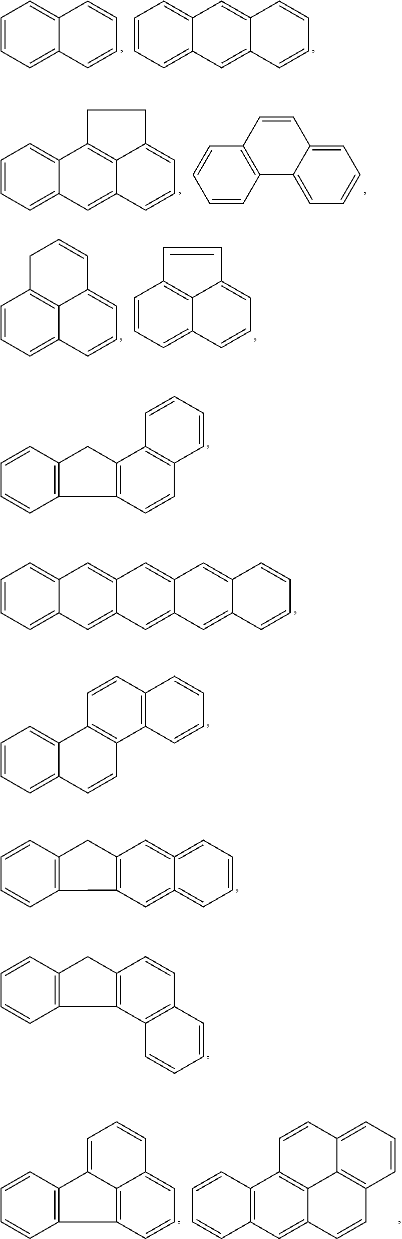

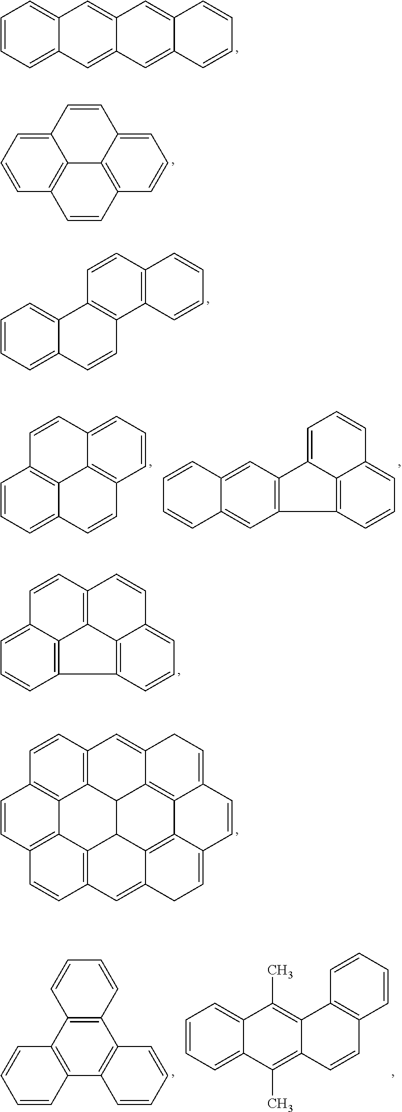

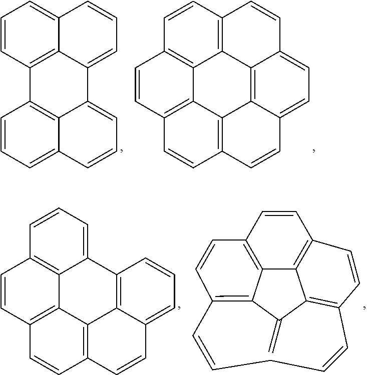

and mixtures thereof; and X₁′ is selected from the group consisting of

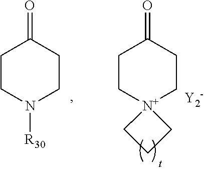

optionally

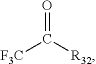

and mixtures thereof; wherein Y₂ is an anion; wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group; wherein R₂₉ and R₃₀ are each independently hydrogen, an alkyl group, an alkenyl group, an alkynyl group, or an aryl group, and the alkyl, alkenyl, alkynyl or aryl groups are optionally substituted with a halide or a positively charged functional group; wherein R₃₂ is an alkyl group, an alkenyl group, an alkynyl group, or an aryl group, and the alkyl, alkenyl, alkynyl or aryl group is optionally substituted with a halide or a positively charged functional group; wherein A is O, S, or NR₁₀₀; wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group; wherein p is 1, 2, 3, or 4; wherein q is 0, 1, 2, or 3; and wherein t is 1, 2, 3, 4, 5, or 6. An embodiment of the invention is one, any or all of prior embodiments in this paragraph up through the first embodiment in this paragraph wherein Ar₁′ is selected from the group consisting of

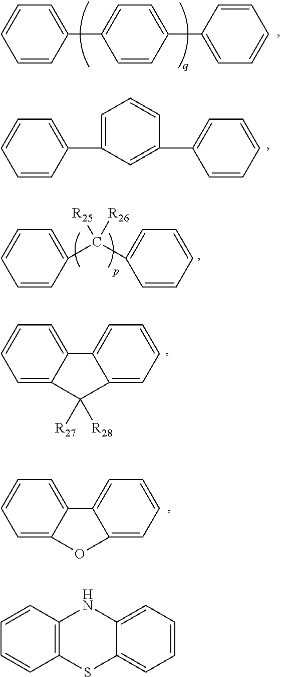

and mixtures thereof, wherein R₂₅, R₂₆, R₂₇, and R₂₈ are each independently —H or —CH₃; wherein p is 1 or 2; and wherein q is 0 or 1. An embodiment of the invention is one, any or all of prior embodiments in this paragraph up through the first embodiment in this paragraph wherein Ar₂′ is selected from the group consisting of

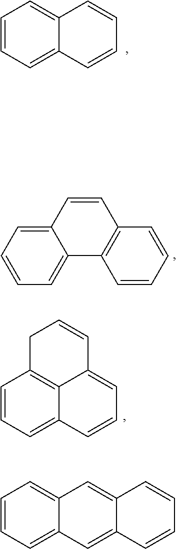

and mixtures thereof. An embodiment of the invention is one, any or all of prior embodiments in this paragraph up through the first embodiment in this paragraph wherein Ar₂′ is selected from the group consisting of

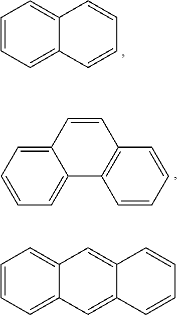

and mixtures thereof. An embodiment of the invention is one, any or all of prior embodiments in this paragraph up through the first embodiment in this paragraph wherein X₁′ is

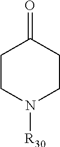

and wherein R₃₀ is —H, —CH₃, —CH₂CH₃, —CH(CH₃)₂, —C(CH₃)₃, —CH₂—C₆H₅, or —CH₂—CH(CH₃)₂. An embodiment of the invention is one, any or all of prior embodiments in this paragraph up through the first embodiment in this paragraph wherein X₁′ is

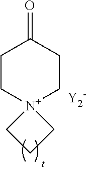

and wherein t is 1, 2, 3, 4, 5, or 6. An embodiment of the invention is one, any or all of prior embodiments in this paragraph up through the first embodiment in this paragraph wherein X₁′ is a mixture of

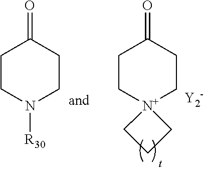

wherein R₃₀ is —H, —CH₃, —CH₂CH₃, —CH(CH₃)₂, —C(CH₃)₃, —CH₂—C₆H₅, or —CH₂—CH(CH₃)₂; and wherein t is 1, 2, 3, 4, 5, or 6.

A second embodiment of the invention is an anion exchange membrane comprising the anion exchange polymer of the first embodiment. An embodiment of the invention is one, any or all of prior embodiments in this paragraph up through the second embodiment in this paragraph, wherein the anion exchange membrane is used in a fuel cell, an electrolyzer, a flow battery, an electrodialyzer, a waste metal recovery system, an electrocatalytic hydrogen production system, a desalinator, a water purifier, a waste water treatment system, an ion exchanger, or a CO₂ separator. An embodiment of the invention is one, any or all of prior embodiments in this paragraph up through the second embodiment in this paragraph wherein the anion exchange membrane comprises a nonporous symmetric dense film membrane, an integrally-skinned asymmetric membrane, a reinforced composite membrane, or a thin film composite membrane. An embodiment of the invention is one, any or all of prior embodiments in this paragraph up through the second embodiment in this paragraph wherein the integrally-skinned asymmetric membrane, the reinforced composite membrane, or the thin film composite membrane comprises a porous substrate material impregnated or coated with the anion exchange polymer.

A third embodiment of the invention is a membrane electrode assembly, comprising an anion exchange membrane comprising the anion exchange polymer of the first embodiment; an anode comprising an anode catalyst on a first surface of the anion exchange membrane; and a cathode comprising a cathode catalyst on a second surface of the anion exchange membrane.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An anion exchange polymer comprising a plurality of repeating units of formula (I) 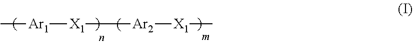
wherein Ar₁ is selected from the group consisting of: 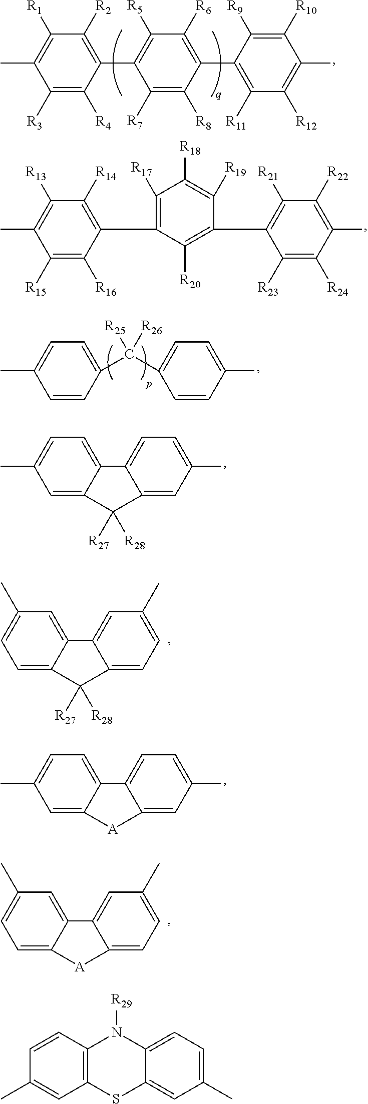
and mixtures thereof,
Ar₂ is selected from the group consisting of: 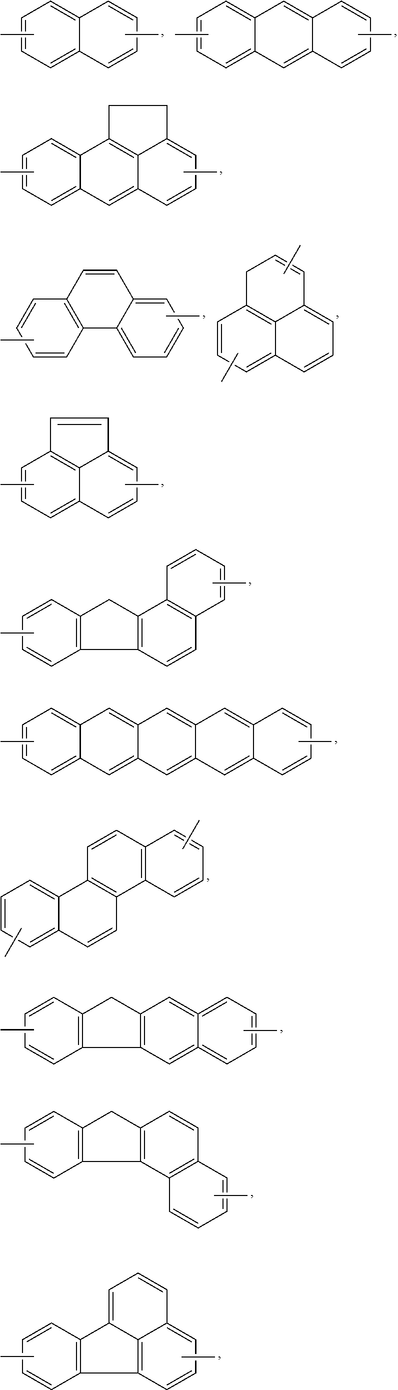 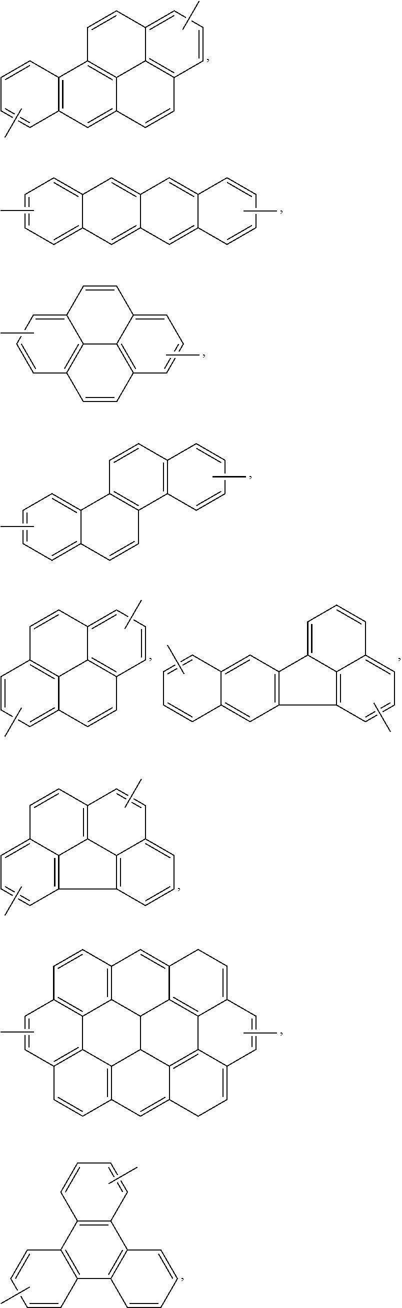 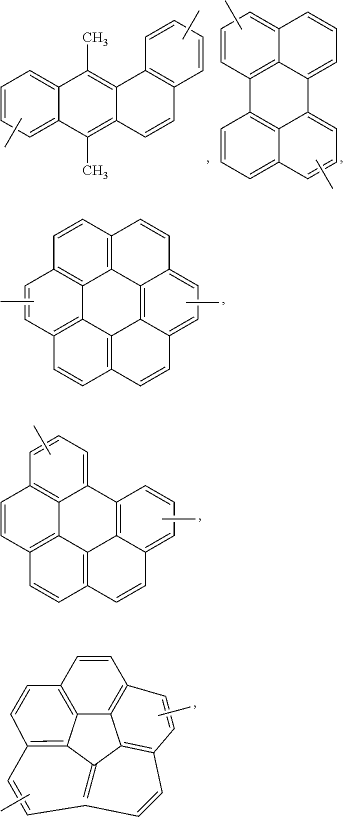
and mixtures thereof;
X₁ is selected from the group consisting of: 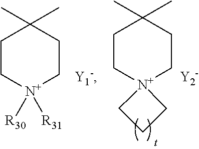
optionally 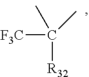
and mixtures thereof;
wherein Y₁⁻ and Y₂⁻ are anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein m is an integer from 5 to 500;
wherein n is an integer from 0 to 500 and the molar ratio of n/m is in a range of 0:1 to 20:1;
wherein p is 1, 2, 3, or 4;
wherein q is 0, 1, 2, or 3; and
wherein t is 1, 2, 3, 4, 5, or 6.

2. The anion exchange polymer of claim 1 wherein Ar₁ is selected from the group consisting of 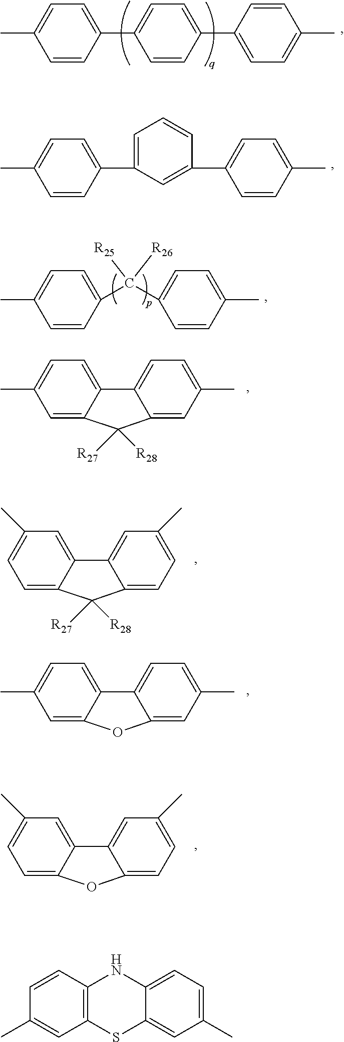
and mixtures thereof,
wherein R₂₅, R₂₆, R₂₇, and R₂₈ are each independently —H or —CH₃;
wherein p is 1 or 2; and
wherein q is 0 or 1.

3. The anion exchange polymer of claim 1 wherein Ar₂ is selected from the group consisting of 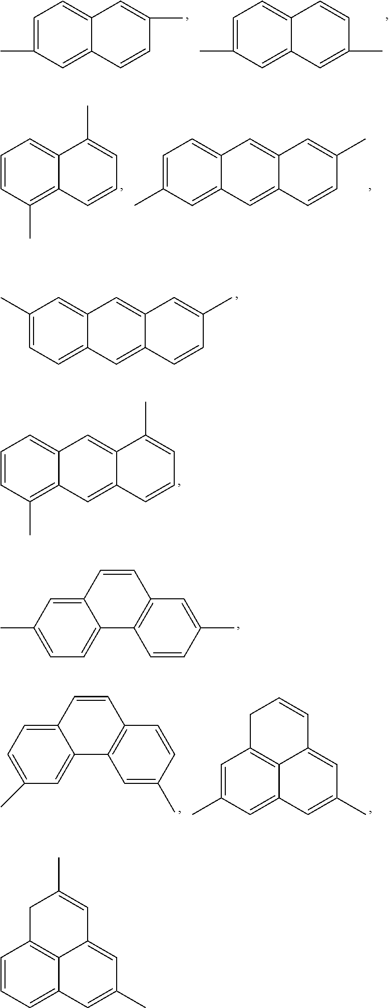
and mixtures thereof.

4. The anion exchange polymer of claim 1 wherein Ar₂ is selected from the group consisting of 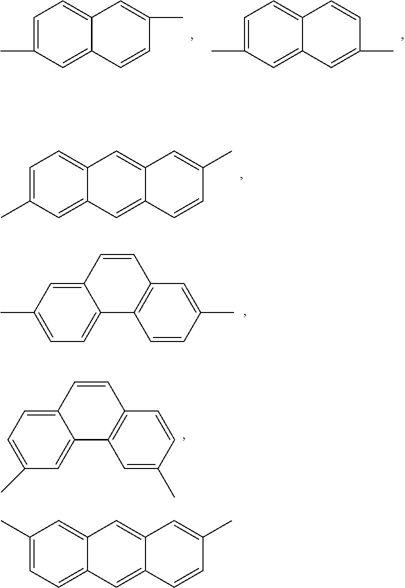
and mixtures thereof.

5. The anion exchange polymer of claim 1 wherein X₁ is 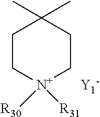
and wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂; and
wherein Y₁⁻ is HCO₃⁻, OH⁻ or I⁻.

6. The anion exchange polymer of claim 1 wherein X₁ is 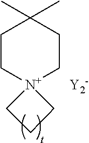
wherein t is 1, 2, 3, 4, 5, or 6; and
wherein Y₂ is HCO₃⁻, OH⁻ or I⁻.

7. The anion exchange polymer of claim 1 wherein X₁ is a mixture of 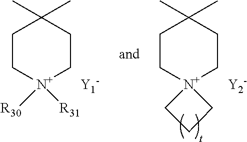
wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂;
wherein t is 1, 2, 3, 4, 5, or 6; and
wherein Y₁⁻ and Y₂⁻ are selected from HCO₃⁻, OH⁻ or I⁻.

8. The anion exchange polymer of claim 1 wherein the anion exchange polymer is synthesized from monomers Ar₁′, Ar₂′, and X₁′ wherein Ar₁′ is selected from the group consisting of: 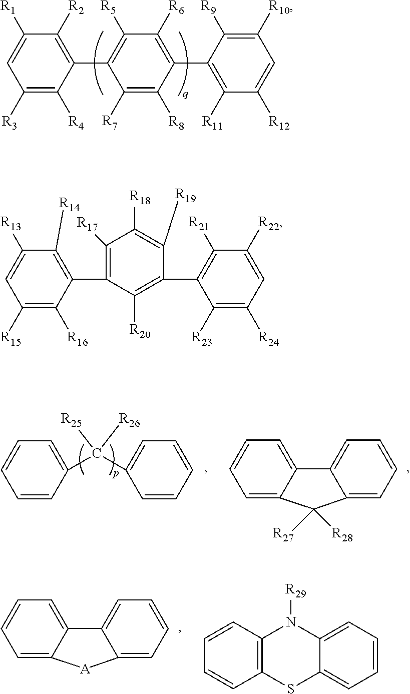
and mixtures thereof,
Ar₂′ is selected from the group consisting of: 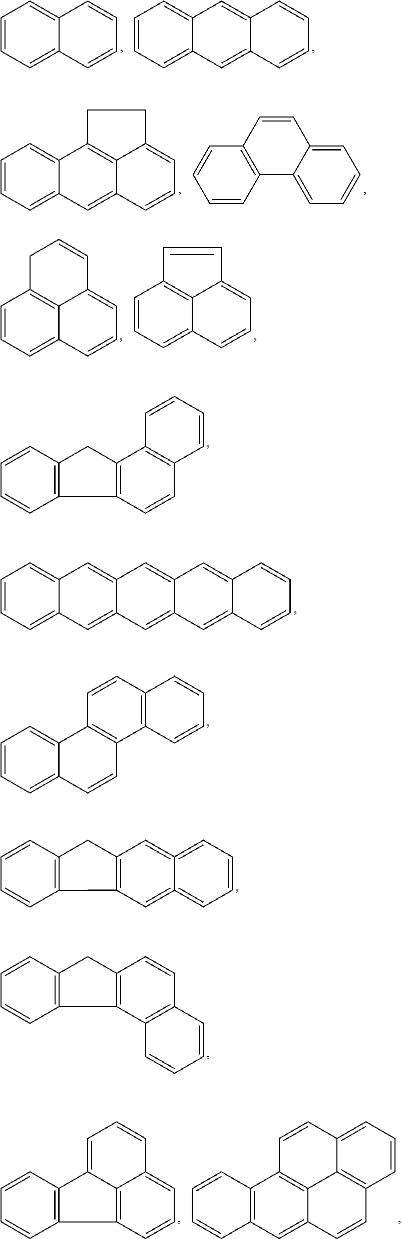 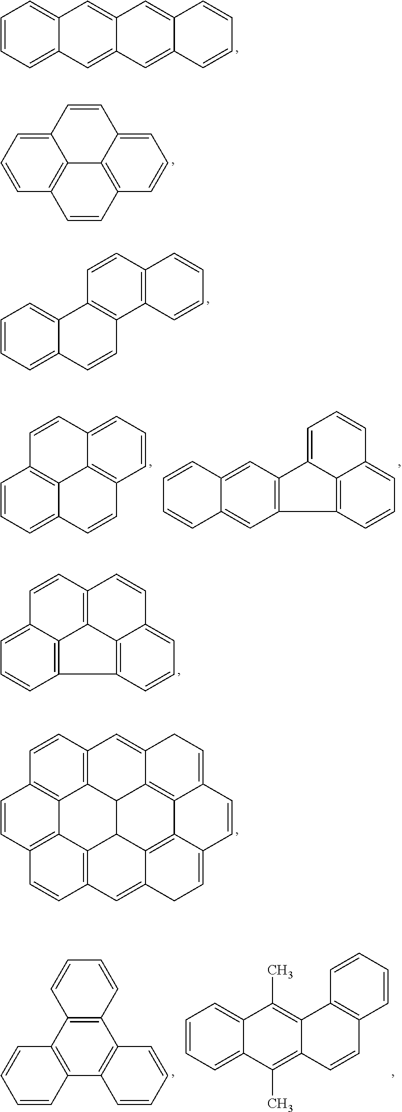 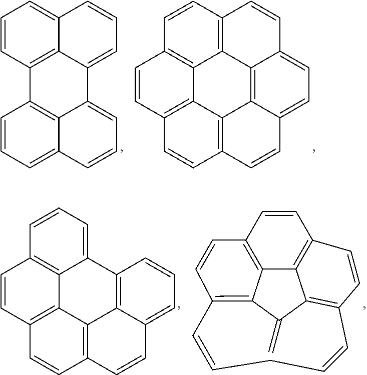
and mixtures thereof, and
X₁′ is selected from the group consisting of: 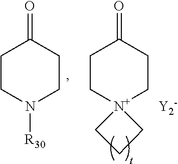
optionally 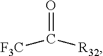
and mixtures thereof,
wherein Y₂⁻ is an anion;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉ and R₃₀ are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein p is 1, 2, 3, or 4;
wherein q is 0, 1, 2, or 3; and
wherein t is 1, 2, 3, 4, 5, or 6.

9. The anion exchange polymer of claim 8 wherein Ar₁′ is selected from the group consisting of: 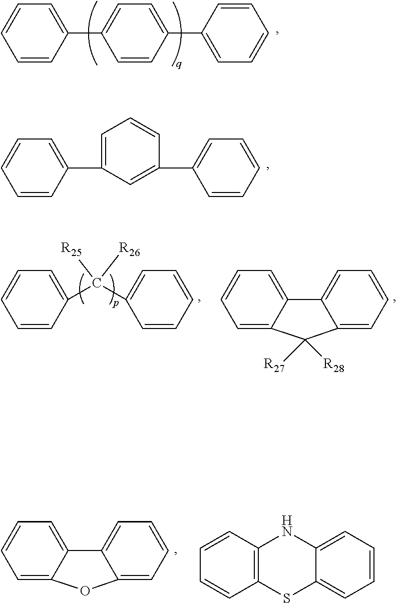
and mixtures thereof,
wherein R₂₅, R₂₆, R₂₇, and R₂₈ are each independently —H or —CH₃;
wherein p is 1 or 2; and
wherein q is 0 or 1.

10. The anion exchange polymer of claim 8 wherein Ar₂′ is selected from the group consisting of: 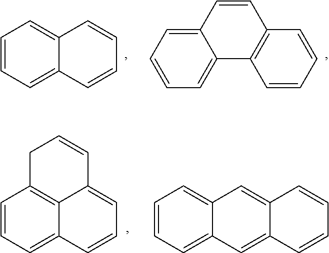
and mixtures thereof.

11. The anion exchange polymer of claim 8 wherein Ar₂′ is selected from the group consisting of: 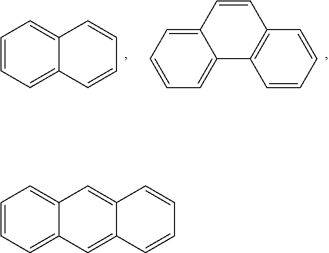
and mixtures thereof.

12. The anion exchange polymer of claim 8 wherein X₁′ is 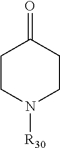
and wherein R₃₀ is —H, —CH₃, —CH₂CH₃, —CH(CH₃)₂, —C(CH₃)₃, —CH₂—C₆H₅, or —CH₂—CH(CH₃)₂.

13. The anion exchange polymer of claim 8 wherein X₁′ is 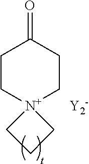
and wherein t is 1, 2, 3, 4, 5, or 6.

14. The anion exchange polymer of claim 8 wherein X₁′ is a mixture of 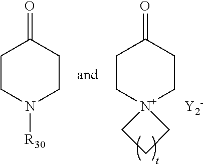
wherein R₃₀ is —H, —CH₃, —CH₂CH₃, —CH(CH₃)₂, —C(CH₃)₃, —CH₂—C₆H₅, or —CH₂—CH(CH₃)₂;
and wherein t is 1, 2, 3, 4, 5, or 6.

15. An anion exchange membrane comprising the anion exchange polymer of claim 1.

16. The anion exchange membrane of claim 15, wherein the anion exchange membrane is used in a fuel cell, an electrolyzer, a flow battery, an electrodialyzer, a waste metal recovery system, an electrocatalytic hydrogen production system, a desalinator, a water purifier, a waste water treatment system, an ion exchanger, or a CO₂ separator.

17. The anion exchange membrane of claim 15 wherein the anion exchange membrane comprises a nonporous symmetric dense film membrane, an integrally-skinned asymmetric membrane, a reinforced composite membrane, or a thin film composite membrane.

18. The anion exchange membrane of claim 17 wherein the integrally-skinned asymmetric membrane, the reinforced composite membrane, or the thin film composite membrane comprises a porous substrate material impregnated or coated with the anion exchange polymer.

19. A membrane electrode assembly, comprising:
an anion exchange membrane comprising the anion exchange polymer of claim 1;
an anode comprising an anode catalyst on a first surface of the anion exchange membrane; and
a cathode comprising a cathode catalyst on a second surface of the anion exchange membrane.

20. The membrane electrode assembly of claim 19 further comprising:
an anode porous transport layer adjacent to the anode; and
a cathode porous transport layer adjacent to the cathode.
